(19) United States
(12) Patent Application Publication
(10) Pub. No.: US 2007/0163548 A1
(43) Pub. Date: Jul. 19, 2007

(54) Cooling device for a fuel-recirculation circuit

(76) Inventor: Roberto Defilippi, Torino (IT)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 10/572,879

(22) PCT Filed: Sep. 21, 2004
(86) PCT No.: PCT/EP04/52259

§ 371 Date: Dec. 11, 2006

(30) Foreign Application Priority Data
Sep. 24, 2003 (IT) TO2003A000743

(51) Int. Cl. F02M 37/00; F02M 15/00

(52) U.S. Cl. 123/514; 123/541

(57) ABSTRACT

Described herein is a cooling device for a fuel-recirculation circuit from the injection system to the tank of a motor vehicle, which has a first opening and a second opening for connection to said recirculation circuit and comprises a pipe and a finned radiant body in a relationship of heat exchange with the pipe, in which the pipe is defined by a through cavity of the radiant body and comprises guide means for guiding the flow of fuel, said guide means being housed in said pipe in order to define at least one path of flow of the fuel adjacent to a side wall of the pipe.

### TECHNICAL FIELD

The present invention relates to a cooling device for a fuel-recirculation circuit from the injection system to the tank of a motor vehicle.

### BACKGROUND ART

Recently, there has been a widespread use of injection systems that enable reduced levels of consumption to be obtained but call for high values of pressure and hence of temperature of the fuel.

Generally, the injection systems referred to comprise pumps sized for supplying a quantity of fuel greater than the one actually used. The amount in excess is recirculated to the tank, where, however, the upper limit of the input temperature of the fuel is set by current standards at a value lower than that of the output temperature from the injection system.

For these reasons a cooling device designed to dissipate the heat of the fuel is used.

As is known, there exist air-cooling devices comprising a coil traversed by the fuel and a thin radiant plate, set in contact with the coil itself and having the function of increasing the dissipation of heat. In particular, the radiant plate comprises a multiplicity of fins, which are semi-blanked and bent outwards in order to favour heat exchange by interacting with the current of air in relative motion with respect to the vehicle.

However, the cooling devices described above present the drawbacks of having large overall dimensions and of requiring a procedure of assembly of the radiant plate that is critical for the purposes of obtaining an optimal heat exchange.

### DISCLOSURE OF INVENTION

The purpose of the present invention is to provide a cooling device that is free from by the drawbacks referred to above.

The purpose of the present invention is achieved via a cooling device for a fuel-recirculation circuit from the injection system to the tank of a motor vehicle, as defined in claim 1.

### BRIEF DESCRIPTION OF THE DRAWINGS

For a better understanding of the present invention there is now described a preferred embodiment, purely by way of non-limiting example, with reference to the annexed drawings, in which:

FIG. 1 illustrates a cooling device according to a perspective view;

FIG. 2 is an enlarged longitudinal section of a detail of the cooling device according to the line II-II of FIG. 1; and

FIG. 3 is a cross-sectional view according to the line III-III of FIG. 1 of the cooling device according to a different embodiment.

### BEST MODE FOR CARRYING OUT THE INVENTION

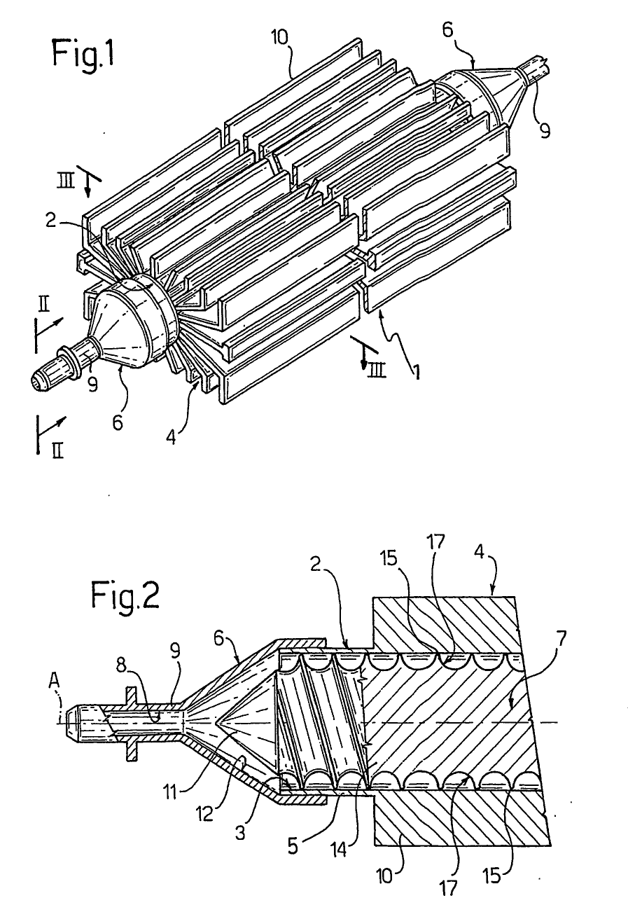

In FIG. 1 designated as a whole by 1 is a cooling device for a fuel-recirculation circuit from the injection system to the tank of a motor vehicle.

The cooling device 1 comprises: a pipe 2 defining a rectilinear cavity 3 of axis A, supporting a finned radiant body 4 and having a side wall 5; two end couplings 6, which can be hermetically connected to the pipe 2; and guide means 7 for guiding the flow of fuel, which are housed within the cavity 3.

The end couplings 6 have a substantially conical shape and have respective openings 8, arranged on respective vertex portions 9 for connecting the cooling device 1 to the recirculation circuit.

The pipe 2 and the finned body 4, which comprises a multiplicity of fins 10, are made of conductive material, for example aluminium, and can be made integrally via processes of plastic deformation, for example by extrusion.

The guide means 7 are made of polymeric material and comprise end portions 11, which have a conical profile, with an angle of opening greater than that of the end couplings 6 and delimiting, together with the couplings 6 themselves, an input chamber 12 for inflow of the fuel and an outlet chamber set downstream of the input chamber 12.

The body 7 moreover comprises, integrally with the end portions 11, an elongated body 14, which, circumferentially, has one or more projections 15, either helical or rectilinear, which start from the input chamber 12 and terminate in the outflow chamber, delimiting respective grooves 16. The internal surface of the cavity 3, and the projections 15 co-operate by mutual interference, thus providing a fixed connection of the guide means 7 within the pipe 2 and, moreover, one or more internal channels 17, which connect the input chamber 12 with the outlet chamber.

Operation of the cooling device 1 is described in what follows.

The fuel at high temperature arriving from the injection system enters the input chamber 12 through the opening 8 and is conveyed to the inlet of the internal channel or internal channels 17 from the conical end portion 11 of the guide means 7. The internal channels 17 modify the geometry of the passage section, enabling the fuel to moisten a larger surface and, in the case of helical channels, increase the stay time and the turbulence of the motion, thus increasing heat exchange. Furthermore, the presence of the multiplicity of fins 10, in so far as these offer a large surface, enables dissipation of the heat to the external environment. Consequently, the fuel reduces its own temperature and finally, once collected in the outflow chamber, is conveyed to the tank.

From an examination of the characteristics of the cooling device 1 built according to the present invention, the advantages that it makes possible are evident.

In particular, the internal channels 17 enable an increase in heat exchange, at the same time maintaining compact dimensions. Furthermore, the radiant body 4 is integral with the pipe 2, thus eliminating the problems linked to the type and to the thermal efficiency of the means of connection, and has a multiplicity of fins that increase the power of dissipation.

Finally, the fact that the elongated body 14 and the pipe 2 are made of materials which have different coefficients of thermal expansion enables the formation of the internal channels 17, in which the passage section can vary with the temperature. In particular, when, in conditions of low temperature, the fuel has a greater density, the passage section of the internal channels 17 tends to increase, so facilitating advance of the flow of fuel.

Finally, it is clear that modifications and variations can be made to the cooling device 1 described and illustrated herein, without thereby departing from the sphere of protection of the present invention, as defined in the annexed claims.

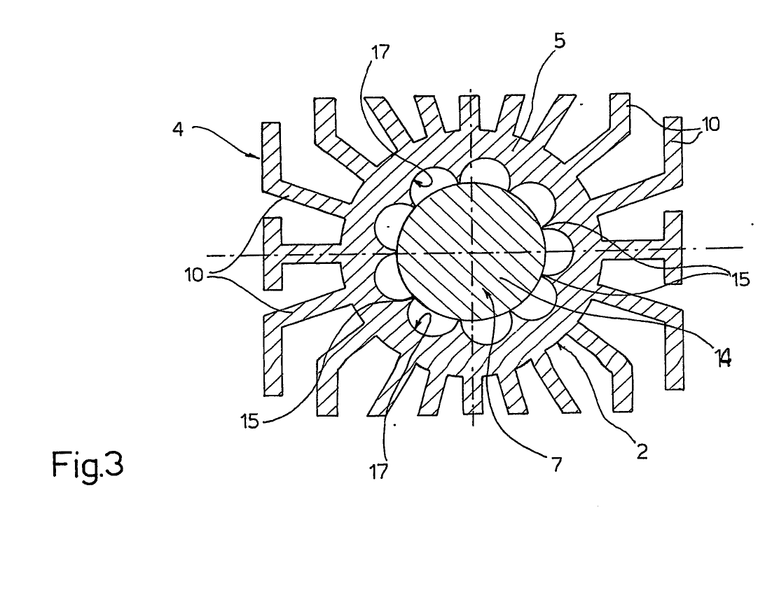

In particular, the projections 15 can be carried by the pipe 2 (FIG. 3), which may for example be made of a single piece via a process of extrusion.

According to this second embodiment, moreover, the side surface of the elongated body 14 has a profile, for example circular, which enables coupling to the projections 15 of the pipe 2, thus forming the internal channels 17.

1. The cooling device (1) for a fuel-recirculation circuit from the injection system to the tank of a motor vehicle, which has a first opening (8) and a second opening (8) for connection to said recirculation circuit and comprises a pipe (2) having a side wall (5) and a finned radiant body (4) in a relationship of heat exchange with said pipe (2), said cooling device being characterized in that said pipe (2) is defined by a through cavity (3) of said radiant body (4) and in that it comprises guide means (7) for guiding the flow of fuel, said guide means (7) being housed in said pipe (2) in order to define at least one path of flow of said fuel adjacent to a side wall of said pipe (2).

2. The cooling device according to claim 1, characterized in that said radiant body (4) comprises a plurality of fins (10) that are longitudinal with respect to said pipe (2).

3. The cooling device according to claim 2, characterized in that said longitudinal fins (10) are arranged in spoke-like fashion with respect to said pipe (2).

4. The cooling device according to any one of the preceding claims, characterized in that said guide means (7) comprise an elongated body (14) inside said pipe (2).

5. The cooling device according to claim 4, characterized in that said elongated body (14) is coaxial to said pipe (2).

6. The cooling device according to claim 4 or claim 5, characterized in that said elongated body (14) has at least one tapered end (11).

7. The cooling device according to one of claims 4 to 6, characterized in that said elongated body (14) is made of polymeric material.

8. The cooling device according to one of claims 4 to 7, characterized in that said elongated body (14) carries projections (15) in contact with said side wall (5) of said pipe (2), thus defining internal passages traversed by said fuel.

9. The cooling device according to one of claims 4 to 7, characterized in that said pipe (2) carries projections (15) in contact with said elongated body (14), so defining internal passages traversed by said fuel.

10. The cooling device according to claim 9, characterized in that said elongated body (14) has a circular cross section.

11. The cooling device according to one of claims 8 to 10, characterized in that said projections (15) are helical.

12. The cooling device according to one of claims 8 to 10, characterized in that said projections (15) are longitudinal.

13. The cooling device according to one of claims 8 to 12, characterized in that said elongated body (14) is interference fitted in said cavity (3).

14. The cooling device according to any one of the preceding claims, characterized in that it comprises end couplings (6) connected hermetically to said pipe (2).

15. The cooling device according to claim 14, characterized in that at least one coupling (6) comprises a substantially conical portion housing a respective end (11).

16. Method for manufacturing a cooling device (1) for a fuel-recirculation circuit from the injection system to the tank of a motor vehicle, which has a first opening (8) and a second opening (8) for connection to said recirculation circuit a finned radiant body (4), a pipe (2) carried by said finned radiant body (4) in a relationship of heat exchange with said radiant body (4), and guide means (7) for guiding the flow of fuel, said guide means (7) being housed in said pipe (2) in order to define at least one path of flow of said fuel adjacent to a side wall of said pipe (2), said method being characterized by the fact of comprising the following steps:
manufacturing said finned radiant body (4) by an extrusion process;
mounting with an interference fitting said guide means (7) into said pipe (2);
hermetically connecting to said pipe (2) a first and a second coupling (6) respectively defining said first and second opening (8).
